(19) United States
(12) Patent Application Publication
(10) Pub. No.: US 2007/0135957 A1
(43) Pub. Date: Jun. 14, 2007

(54) Model generating apparatus, model generating system, and fault detecting apparatus

(75) Inventors: Makoto Ogawa, Kawasaki-shi (JP); Toshikazu Nakamura, Kawasaki-shi (JP); Yoshikazu Aikawa, Tokyo (JP); Shigeru Obayashi, Mishima-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/606,383

(22) Filed: Nov. 30, 2006

(30) Foreign Application Priority Data
Dec. 13, 2005 (JP) 2005-359422

(51) Int. Cl. G06F 19/00

(52) U.S. Cl. 700/109; 700/121; 700/110

(57) ABSTRACT

A model generating apparatus includes: a first input device for inputting process state information; a second input device for inputting test result information; a characteristic quantity extracting device for extracting a process characteristic quantity from the process state information in each of the areas; and an analyzing device for generating a process-quality model by executing an analysis of data mining using the process characteristic quantity and the test result information associated with each other. The model generating apparatus further includes: a third input device for inputting process position information so that the process position information can be associated with the process state information; and a fourth input device for inputting test position information so that the test position information can be associated with test result information.

This application claims priority from Japanese patent application 2005-359422, filed on Dec. 13, 2005. The entire content of the aforementioned application is incorporated herein by reference.

### BACKGROUND OF THE INVENTION

1. Field of the Invention

The present invention relates to acquisition of process state information which is related to the state of a process and may exert an influence on the quality of an object to be processed, and test result information of the object, and generation of a process-quality model indicative of the relation between a process characteristic quantity extracted from the process state information and test result information, or fault detection using the process-quality model.

2. Description of the Related Art

Manufacturing processes of various products including a semiconductor and a liquid crystal panel have to be properly controlled to improve the manufacturing yield of the products or to maintain a state where the yield is excellent.

Japanese Unexamined Patent Publication No. H9-219347 describes a technique of associating device state data such as degree of vacuum of a CVD apparatus and heater power and product data such as the yield and electric characteristics of a manufactured semiconductor device with time at which the data is obtained, analyzing the correlation, setting control criteria of the device state data by using the result of analysis, and clarifying the cause of a failure.

Japanese Unexamined Patent Publication No. 2002-323924 describes a technique of performing an analysis using data mining by using process history data indicative of devices that performed processes and finish data indicative of finish of the process in order to specify a defective device exerting a large influence on deterioration in yield at the time of mass-producing products by using a plurality of manufacturing apparatuses having equivalent functions.

Japanese Unexamined Patent Publication No. 2005-197323 describes a technique of obtaining process state information in time series during a period in which process steps constructing a process are executed, and generating a process-quality model indicative of the relation between a process characteristic quantity extracted from the process state information and test result information.

In the technique described in Japanese Unexamined Patent Publication No. H9-219347, proper control criteria for a focused parameter can be just known. However, a parameter to be focused is left to the judgment of a person. Therefore, finding of whether a parameter which is not focused by a person exerts an influence on the yield or not cannot be obtained.

In the technique disclosed in Japanese Unexamined Patent Publication No. 2002-323924, a defective device can be specified. However, the cause of the defect cannot be analyzed specifically.

In the technique disclosed in Japanese Unexamined Patent Publication No. 2005-197323, process state information can be obtained in time series during the period in which the process step is executed. However, the process state information and the test result information are associated only on the object unit basis, and variations in quality in one object cannot be analyzed.

Further, the size of a process equipment such as a liquid crystal manufacturing apparatus in recent years is increasing year by year, and a process executed by the process equipment has changed largely. For example, a coater of a spin method or a method using both slit and spin for rotating a glass substrate is in the mainstream. It is becoming difficult to rotate a glass substrate which is becoming larger, and a slit method (spinless method) by ink jet is being devised. Consequently, in a conventional liquid crystal manufacturing apparatus, by applying a resist first and rotating the substrate, uneven coating of a resist film is prevented. In the slit coating, a resist has to be applied without causing uneven coating.

However, in the conventional control systems, quality control in semiconductor manufacture and liquid crystal manufacture is performed in a lot unit or a wafer unit. Therefore, variations in quality in a screen cannot be analyzed and controlled. As a result, in the case where uneven coating occurs in a resist film on a liquid crystal panel manufactured by using a slit-coating-method liquid crystal manufacturing apparatus, the conventional control system cannot analyze the cause and it is difficult to control the operation of the process equipment (liquid crystal manufacturing apparatus) so as to suppress occurrence of uneven coating or the like.

An object of the present invention is to enable variations in quality in one product (object) such as a wafer or a glass substrate to be analyzed, moreover, to generate a model which can be used for estimating the quality of an object on the basis of many kinds of information which are not narrowed by prediction on the relation with the quality of an object to be processed, or determine a fault in a process by paying attention to variations in the quality in a single product. The other objects of the present invention will become apparent from the following description.

### SUMMARY OF THE INVENTION

(1) According to the present invention, a model generating apparatus for a process in which a target position of a process sequentially moves over an object and used in the case where a plurality of areas are set on the object, includes: a first input device for inputting process state information as information related to a state of a process, which is obtained in time sequence during a period in which the process is executed; a second input device for inputting test result information as information of a test result obtained in each of a plurality of test positions on an object processed in the process; a characteristic quantity extracting device for extracting a process characteristic quantity from the process state information in each of the areas; and an analyzing device for generating a process-quality model indicative of the relation between the process characteristic quantity and the test result information by executing an analysis of data mining using the process characteristic quantity and the test result information associated by detecting that the area corresponding to the process characteristic quantity and the area to which the test position belongs are the same.

By the model generating apparatus, in a process in which a target position of a process sequentially moves over an object, a process-quality model which can be obtained with respect to the state of a process and can be used for estimating the quality of the object on the basis of a number of kinds of information which are not narrowed by prediction related to the quality can be generated. In particular, since the process state information obtained in time series is used, a model can be generated on the basis of a sufficient amount of information. Since a plurality of areas are set in the plane of a wafer or an object such as a glass substrate, and a process characteristic quantity extracted from process state information corresponding to each area and test result information are used, a model in which features in the respective areas are reflected can be generated. For example, by analyzing the relation between the process characteristic quantity and the test result information on an area unit basis with respect to a process from the process start position to the end position on an object, a process-quality model in which changes in the process characteristic quantity in the plane are also reflected can be generated.

The “process” includes a manufacturing process. The object manufactured by the manufacturing process includes a semiconductor and an FPD (Flat Panel Display which is a display using liquid crystal, PDP, EL, FED, or the like). As the input devices, a single input device can be used.

The data mining is a method of extracting a rule or a pattern from a large-scale database. As concrete methods of the data mining, a method called decision tree analysis and a method called regression tree analysis are known.

In the case where the model generating apparatus is used for a plurality of kinds of processes, preferably, a process-quality model is generated for each of the kinds and associated with process specification information as information that specifies the kind of a process, and the resultant is stored in the model generating apparatus or another apparatus.

(2) The model generating apparatus further includes: a third input device for inputting process position information specifying a position on the object being processed when the process state information is obtained so that the process position information can be associated with the process state information; a fourth input device for inputting test position information specifying a test position so that the test position information can be associated with test result information; and an area associating device for specifying process state information corresponding to each of the areas by using the process position information. The characteristic quantity extracting device extracts a process characteristic quantity area by area from the process state information in which a corresponding area is specified by the area associating device. A test result associating device is further provided for specifying test result information corresponding to each of the areas by using the test position information and associating the process characteristic quantity and the test result information corresponding to the same area. The analyzing device performs an analysis using the process characteristic quantity and the test result information associated with each other by the test result associating device.

When the process state information corresponds to an area, the position specified by the process position information corresponding to the process state information belongs to the area. When the test result information corresponds to an area, the test position specified by the test position information corresponding to the test result information belongs to the area.

(3) The model generating apparatus may further include an area setting device for setting an area on an object. As an example of the area setting method performed by the area setting device, areas are set so that at least one test position specified by the test position information is included in each of the areas. With the configuration, the process characteristic quantity corresponding to any of areas is also associated with test result information and, the resultant can be used for analysis. An area may be set by an operator as necessary on the basis of an instruction entered to the model generating apparatus. Alternatively, areas determined separately may be preliminarily set in the model generating apparatus.

(4) Concretely, the area setting device may set a plurality of areas so that a border between neighboring areas is set by using the test position as a reference and at least one test position is included in each of the areas.

(5) The area setting device may determine the plurality of areas while setting a predetermined range around each of the test positions.

(6) The area setting device may set the plurality of areas by equally dividing the object into predetermined number of areas so that at least one test position is included in each of the areas.

(7) A model generating system of the present invention includes: a process information collecting device for collecting, from a process equipment, process state information as information related to state of a process which is a resist coating process for coating a substrate with a resist; a test equipment for testing film thickness of the resist on an object subjected to the resist coating process; and the model generating apparatus according to the invention for inputting the process state information from the process information collecting device, inputting test result information on the film thickness from the test equipment, and generating a process-quality model indicative of the relation between a process characteristic quantity extracted from the process state information and the test result information.

(8) The present invention also provides a fault detecting apparatus for a process in which a target position of a process sequentially moves over an object and used in the case where a plurality of areas are set on the object, including: a first input device for inputting process state information as information related to a state of a process, which is obtained in time sequence during a period in which the process is executed; a third input device for inputting process position information specifying a position on the object being processed when the process state information is obtained so that the process position information can be associated with the process state information; a characteristic quantity extracting device for extracting a process characteristic quantity from the process state information in each of the areas; a storing device in which a process-quality model indicative of the relation between the process characteristic quantity and the test result information is stored; and a determining device for determining the presence or absence of a fault on the basis of the process characteristic quantity extracted by the characteristic quantity extracting device and the process-quality model stored in the storing device.

By the model generating apparatus of the present invention, a process-quality model which can be obtained with respect to the state of a process and can be used for estimating the quality of an object on the basis of a number of kinds of information which are not narrowed by prediction related to the quality can be generated. In particular, the model generating apparatus of the invention uses the process state information and test result information of each of areas set in an object (such as a wafer or a glass substrate), so that a process-quality model which can be used for estimating variations in quality in a single object can be generated on the basis of a sufficient amount of information.

### BRIEF DESCRIPTION OF THE DRAWINGS

FIG. 1 shows a liquid crystal panel manufacturing system including a model generating apparatus as an embodiment of the present invention;

FIGS. 2A and 2B show a schematic configuration of a resist liquid coating apparatus mounted on a process equipment;

FIGS. 3A and 3B show a film thickness test;

FIG. 4 shows a schematic configuration of a film thickness test device mounted on a test equipment;

FIG. 5 shows an example of a general configuration of the process equipment;

FIG. 6 shows a connecting state of the elements constructing the system illustrated in FIG. 1 by paying attention to transmission/reception of data;

FIG. 7 shows an example of the internal configuration of the model generating apparatus;

FIG. 8 is a diagram showing an example of data input to the model generating apparatus;

FIG. 9 is a flowchart showing data collection in a process data collecting device and process of registering data to a primary data storage;

FIG. 10 shows an example of an internal data structure in the primary data storage;

FIG. 11 shows an example of an internal data structure in the primary data storage;

FIG. 12 shows an example of an internal data structure in the primary data storage;

FIG. 13 shows an example of the structure of data stored in a test data storage;

FIG. 14 shows generation of areas and allocation of area IDs;

FIG. 15 shows generation of areas and allocation of area IDs;

FIG. 16 shows generation of areas and allocation of area IDs;

FIGS. 17A and 17B show meaning of internal data in an edited test data storage 10n;

FIG. 18 shows an example of the structure of edited test data stored in the edited test data storage;

FIG. 19 shows functions of a data combining unit;

FIG. 20 shows an example of a process-quality model; and

FIG. 21 shows a fault detection system as an embodiment of the invention.

### DETAILED DESCRIPTION OF THE PREFERRED EMBODIMENTS

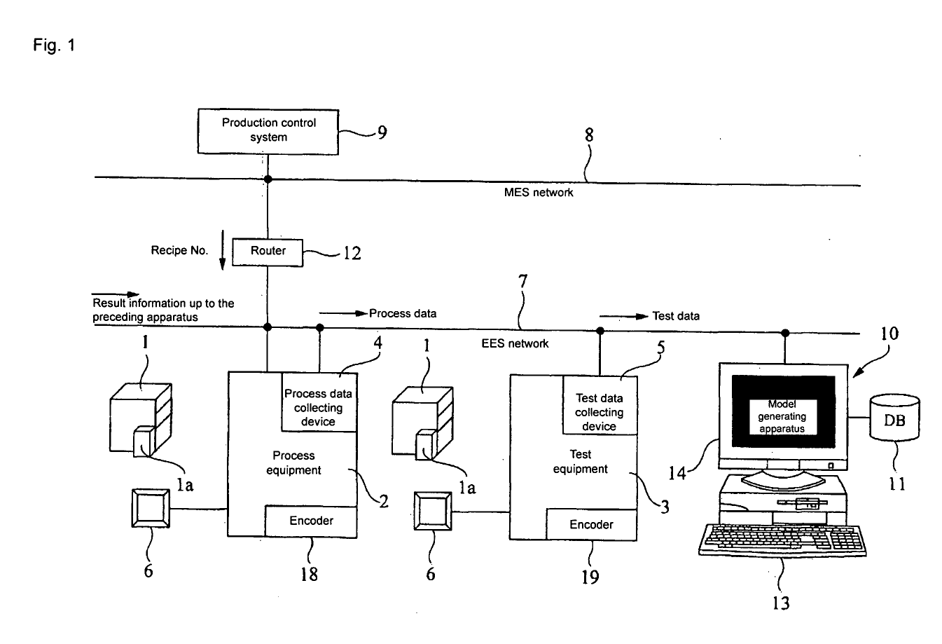

FIG. 1 shows a liquid crystal panel manufacturing system including a model generating apparatus as an embodiment of the present invention. The system includes a process equipment 2, a test equipment 3, and a model generating apparatus 10. Those devices are connected to each other via an EES (Equipment Engineering System) network 7 as a device network for transmitting/receiving process-related information which is more specific than production control information. Although not shown, other process equipment and test equipment used before and after the manufacturing process are also connected to the EES network 7. Further, the system includes a production control system 9 including an MES (Manufacturing Execution System), and an MES network 8 for transmitting production control information, which is connected to the production control system 9. The EES network 7 and the MES network 8 are connected to each other via a router 12. The production control system 9 existing on the MES network 8 can access the devices on the EES network 7 via the router 12.

In the liquid crystal manufacturing system, a predetermined number of glass substrates to be processed are set in a cassette 1, moved between the process equipment 2 and the test equipment 3 on the cassette unit basis and between the devices used in processes before and after the process equipment 2 and the test equipment 3, and subjected to predetermined processes in the devices. The predetermined number of glass substrates mounted in the cassette 1 are in the same lot. An RF-ID (radio frequency identification) tag 1a is attached to the cassette 1. The tag 1a is electromagnetically coupled to an RF-ID read/write head 6 to read/write arbitrary data from/to the tag 1a in a non-contact manner and is also called a data carrier. In the tag 1a, information such as the lot ID and time of unloading from a preceding device is stored.

In the liquid crystal panel manufacturing system of the embodiment, an ID (production ID) is given to each product since it is necessary to control each of the glass substrates (objects which are products in the embodiment). The product ID can be set, for example, by connecting the lot ID and an identification number in the lot. To be specific, when the lot ID is “01201” and the number of glass substrates which can be set in one lot is one digit, the product ID for the first glass substrate (the identification number in the log is “1”) in the lot can be set as “012011” obtained by adding the identification number in the lot as the lowest digit. The product ID can be set in a process data collecting device 4 housed in the process equipment 2.

Obviously, product IDs of all of glass substrates may be recorded in place of or together with the lot ID in the tag 1a, and the process equipment 2 (process data collecting device 4) may obtain all of the product IDs stored in the tag 1a. In the case where the number of glass substrate to be set in the cassette 1 is one, the ID recorded in the tag 1a can be used as the product ID.

The process equipment 2 is an apparatus for executing a predetermined process on a glass substrate. The process equipment 2 has therein the process data collecting device (process information collecting device) 4. The process data collecting device 4 collects, in time series, process state data (process state information) as information related to the state of the manufacturing process during the period in which a process is executed in the process equipment 2.

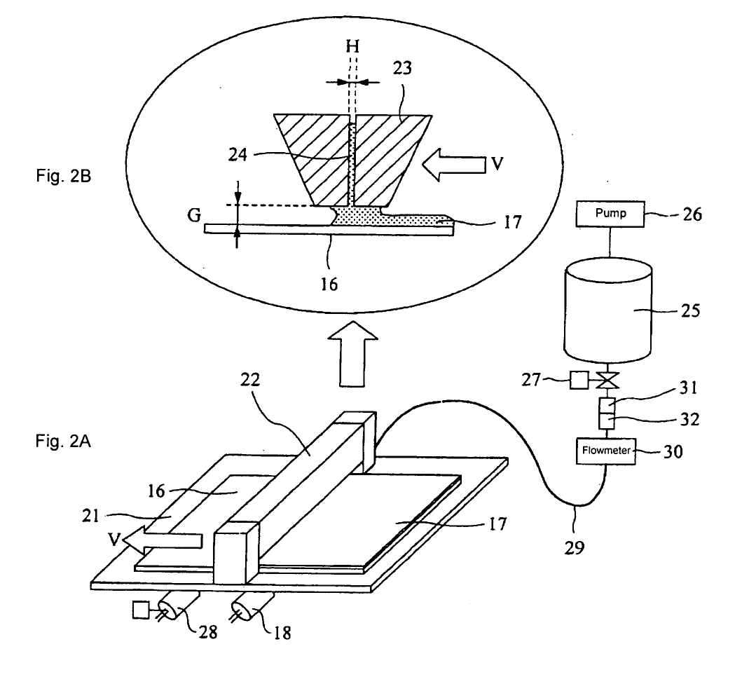

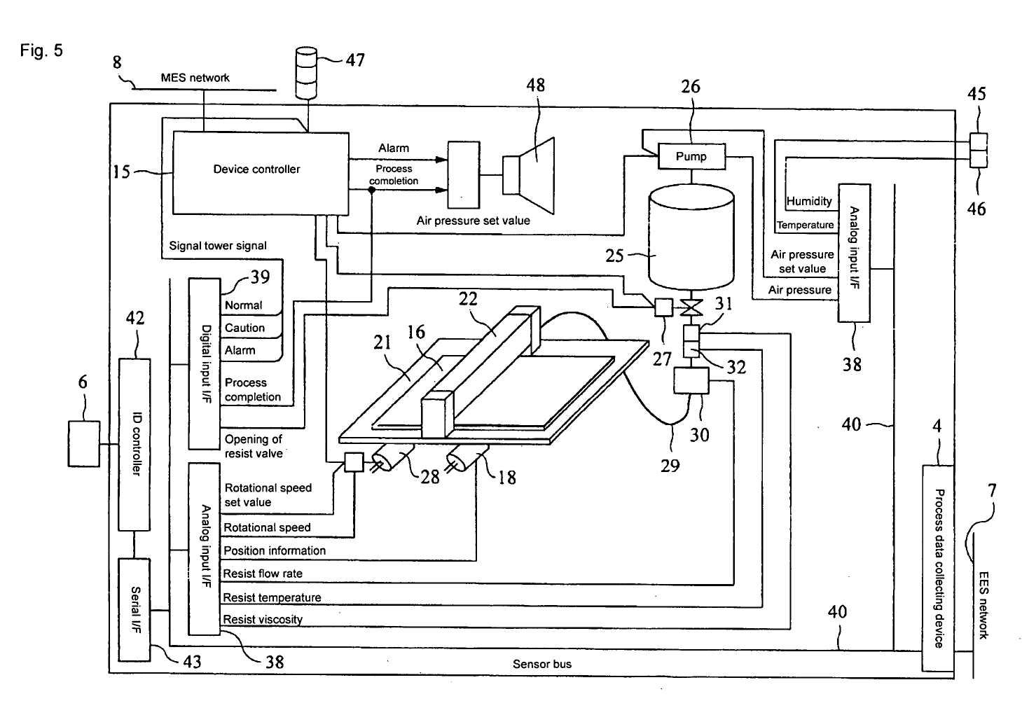

FIGS. 2A and 2B show a resist coater 20 as a main part in the concrete example of the process equipment 2. The process equipment 2 as a whole in this case will be described later with reference to FIG. 5. The resist coater 20 is an apparatus for coating the surface of a loaded glass substrate 16 for a liquid crystal panel with a desired resist by using slit coating (spinless coating) such as an ink jet. The resist coater 20 has a stage 21 for fixing the glass substrate 16 and a nozzle head 22 reciprocatable in one axis direction above the stage 21. For convenience, the travel direction of the nozzle head 22 is set as an X axis direction, and the direction orthogonal to the travel direction is set as a Y axis direction. The nozzle head 22 travels by receiving an output of a driving motor 28. Therefore, in the resist coater 20, travel speed “v” of the nozzle head 22 can be adjusted by adjusting the rotational speed of the drive motor 28 or the mechanism of transmitting power from the drive motor 28 to the nozzle head 22. The direction to the left in FIGS. 2A and 2B is set as the positive direction. The resist coater 20 discharges a resist 17 during travel in the position direction.

As shown in the enlarged view of FIG. 2B, a resist discharge nozzle 23 for discharging a resist is attached to the under face of the nozzle head 22. The resist discharge nozzle 23 has an elongated body longer than the width of the glass substrate 16 (the length in the Y axis direction), and the body is attached to the under face of the nozzle head 22 along the Y axis direction. The resist discharge nozzle 23 has, in its center, a slit 24 extending in the vertical direction, discharges the resist 17 via the slit 24, and coats the surface of the glass substrate 16 with the discharged resist 17. The resist supplied to the nozzle head 22 is stored in a resist storage tank 25 connected via a pipe 29. By opening a resist valve 27 in a state where a pump 26 operates, the resist stored in the resist storage tank 25 flows into the nozzle head 22 at predetermined flow velocity (flow rate) via the pipe 29. The flow rate is measured by a flowmeter 30 provided for the pipe 29. The resist valve 27 may switch between two states of ON and OFF or may adjust the flow rate. The pipe 29 has a viscosity sensor 31 and a temperature sensor 32. The viscosity sensor 31 measures viscosity of the resist flowing in the pipe 29, and the temperature sensor 32 measures the temperature of the resist.

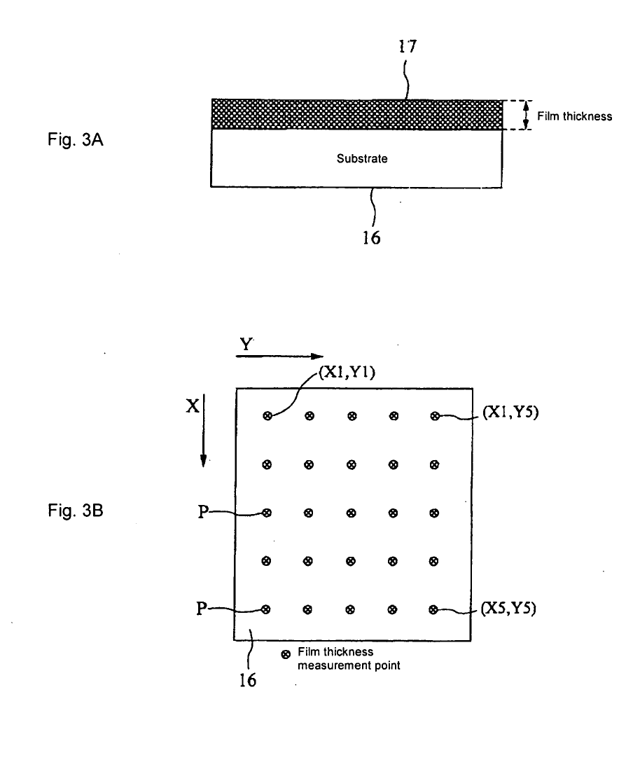

As described above, the resist coater 20 has the slit-type resist discharge nozzle 23 for discharging the resist above the glass substrate 16 fixed on the stage 21, and makes the nozzle head 22 travel in the X axis direction while discharging the resist from the resist discharge nozzle 23. Consequently, as shown in FIG. 3A, the surface of the glass substrate 16 is coated with the resist, and the resist layer 17 having a desired thickness is formed. After the coating process is finished, the process in the process equipment 2 completes. Therefore, the process equipment 2 can be also applied to a large-sized liquid crystal panel which is difficult to be coated with a resist by spin coating. The thickness and the like of the resist layer 17 formed varies according to mechanical parameters such as the head travel speed “v”, the gap G between the glass substrate 16 and the resist discharge nozzle 23, and the slit width H of the slit 24 and various external parameters (process state data) such as viscosity of the discharged resist, flow rate, and ambient temperature.

The resist coater 20 is provided with a first encoder 18 for obtaining position data of the resist discharge nozzle 23 (travel distance from start of the resist coating). The first encoder 18 has the rotation axis of rotation synchronized with the travel of the resist discharge nozzle 23. When the rotation axis rotates only by a unit angle, the first encoder 18 outputs one pulse. The relation between the rotation angle of the rotation axis and the travel distance of the resist discharge nozzle 23 is unconditionally specified by a setting.

The process data collecting device 4 can obtain the travel distance of the resist discharge nozzle 23 on the basis of the number of pulses output from the first encoder 18. Therefore, by preliminarily obtaining the initial position (reference position) from which the resist discharge nozzle 23 starts traveling, the process data collecting device 4 can recognize the present position of the resist discharge nozzle 23, that is, the resist discharge position on the glass substrate 16.

Further, by obtaining information of time required from start time of the resist coating until the resist discharge nozzle 23 reaches a predetermined position by a not-shown timer or the like, the resist coater 20 can also calculate the travel distance “v” of the resist discharge nozzle 23 on the basis of the time information and the travel distance obtained from the output of the first encoder 18.

Referring again to FIG. 1, the RF-ID read/write head 6 is coupled to the process equipment 2. The RF-ID read/write head 6 reads/writes data from/to the tag 1a of the cassette 1 in which the glass substrate set in the process equipment 2 has been housed. The data to be read includes, for example, the ID (the lot ID as the base of the product ID or the product ID itself) and time when the glass substrate left a preceding apparatus (process equipment or the like). The process data collecting device 4 collects the time when the glass substrate was unloaded from the preceding apparatus and the time when the glass substrate was loaded in the process equipment 2 in which the glass substrate is set at present, the times being read from the tag 1a. By calculating the difference between the unload time and the load time, the residence time from the preceding apparatus can be calculated. The RF-ID read/write head 6 writes, as necessary, the unload time and the like to the tag 1a when the glass substrate is unloaded from the process equipment 2.

The process data collecting device 4 has the communication function and outputs the collected process state data so as to be associated with the position data obtained on the basis of the output of the first encoder 18, the residence time data (residence time information), and the product ID to the EES network 7. The residence time data is data of the time of unload from the preceding apparatus and the load time, or the data of the residence time as the difference between the unload time and the load time.

The test equipment 3 conducts a test on the glass substrate 16 processed by the process equipment 2 (for example, the resist coater 20), and outputs test result data (test result information) to the EES network 7. The test result data is, for example, data of a result of a test on the film thickness or film quality of the resist layer 17 formed on the glass substrate 16. As shown in FIG. 3B, in the embodiment, a plurality of test points P are set in a single glass substrate 16. Each of the test points P is specified by using coordinate values (Xn, Yn) of an XY coordinate system which is set on the basis of the travel direction of a test head 62 to be described later.

The RF-ID read/write head 6 is coupled to the test equipment 3. The RF-ID read/write head 6 reads/writes data from/to the tag 1a of the cassette 1 in which a product (the glass substrate 16 coated with the resist) set in the test equipment 3 was housed. Data to be read includes the ID specifying the product (glass substrate). A test data collecting device 5 housed in the test equipment 3 has the communication function, collects test result data, test position coordinate data, and product ID, and outputs the test result data so as to be associated with the test position coordinate data and the product ID to the EES network 7. When the product ID is stored in the tag 1a, it is sufficient for the test data collecting device 5 to collect the product ID as it is. In the case where a lot ID is stored in the tag 1a, the test data collecting device 5 generates a product ID on the basis of the lot ID. A product ID generating process in the test data collecting device 5 may be similar to the product ID generating process in the process data collecting device 4.

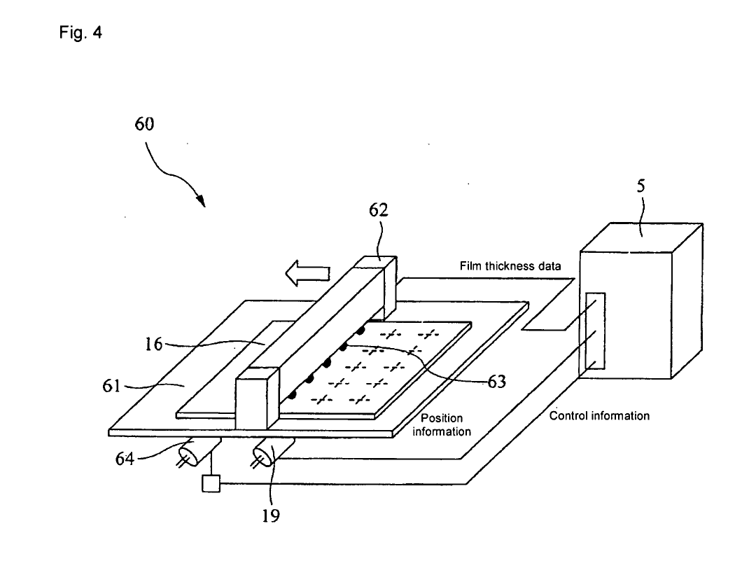

FIG. 4 shows a film thickness tester 60 as an example of the test equipment 3 for conducting a test in each of the test points P in a product to be tested (glass substrate 16). The film thickness tester 60 includes a stage 61 for fixing the glass substrate 16 on which the resist layer 17 to be tested is formed and the test head 62 which can be reciprocated in the direction of one axis above the stage 61. The test head 62 moves by receiving an output of a drive motor 64.

For convenience, the travel direction of the test head 62 is set as an X axis direction, and the direction orthogonal to the travel direction of the test head 62 is set as a Y axis direction. The direction in which the test head 62 travels to the left in FIG. 4 is the positive direction.

A plurality of (five) film thickness sensors 63 are attached in a row in the Y axis direction on the under face of the test head. The film thickness sensor 63 can detect the thickness of the resist layer 17 formed on the surface of the facing glass substrate 16.

The film thickness tester 60 is provided with a second encoder 19 for obtaining position data of the test head 62. The second encoder 19 has the rotation axis of rotation synchronized with the travel of the test head 62. When the rotation axis rotates only by a unit angle, the second encoder 19 outputs one pulse. The relation between the rotation angle of the rotation axis and the travel distance of the test head 62 is unconditionally specified by a setting.

The test data collecting device 5 can obtain the travel distance of the test head 62 on the basis of the number of pulses output from the second encoder 19. Therefore, by preliminarily obtaining the initial position (reference position) from which the test head 62 starts traveling, the test data collecting device 5 can obtain the present position of the test head 62 (film thickness sensor 63), that is, the position in which the test head 62 (film thickness sensor 63) exists on the glass substrate 16.

Therefore, the test data collecting device 5 gives a test instruction to each of the film thickness sensors 63 when the present position of the test head 62 obtained on the basis of the output of the second encoder 19 coincides with the coordinate value (Xn: n=1, 2, . . . ) in the X axis direction of the test point. The test data collecting device 5 obtains a test result (film thickness data) output from each of the film thickness sensors 63 as a response to the test instruction. The coordinate value (Yn: n=1, 2, . . . ) in the Y axis direction orthogonal to the X axis is specified from the set position of each of the film thickness sensors 63.

As described above, the test head 62 tests the film thickness of a facing part in the resist layer on the basis of the test instruction sent from the test data collecting device 5 to the test head 62, and sends the result of the test back to the test data collecting device 5. Alternatively, the film thickness of a facing part may be measured in predetermined sampling intervals and output. The sampling interval is set to be sufficiently short so that sampling can be performed a number of times during travel of the test head 62 from one test point to another test point (from Xn to Xn+1). In such a manner, the film thickness can be measured with reliability at or near a test point. The test data collecting device 5 may obtain a test result (film thickness data) output from the test head 62 and an output from the second encoder 19, fetch the test result which is input when (or immediately after) the test head 62 reaches a test point as test data of the test point, and discard (may not fetch) the other test data.

In such a manner, the test data collecting device 5 collects output (position information) of the second encoder 19 and detection result data (film thickness data) from the film thickness sensor 63. The test data collecting device 5 obtains test position coordinate data as the coordinate values (Xn, Yn) of a test point on the basis of the output of the second encoder, associates the test position coordinate data with the collected test result data, and enters the resultant to the model generating apparatus 10. Further, the test data collecting device 5 gives control information (an instruction value of rotational speed or the like) to the drive motor 64.

The test data collecting device 5 has the communication function, associates the collected test result data (film thickness data) with the test position coordinate data (Xn, Yn) and the product ID, and outputs the resultant to the EES network 7.

The production control system 9 sends recipe No. (process specification information) as information specifying the kind of a process as production instruction information to the process equipment 2. The process equipment 2 executes a predetermined process corresponding to the recipe No.

The model generating apparatus 10 obtains process state data, position data, residence time data, test result data, and test position coordinate data output from the two data collecting devices 4 and 5 via the EES network 7, associates the data by using the product ID, the position data, and the test position coordinate data as keys, and stores the resultant data to the database 11.

The model generating apparatus 10 is a general personal computer from the viewpoint of hardware, and the functions of the apparatus are realized by an application program that runs on an operating system such as Windows™. The model generating apparatus 10 uses a database 11. The database 11 may be provided in a storage such as a hard disk drive which is provided on the inside or outside of the computer as the model generating apparatus 10, or may be provided in another computer that performs communication with the model generating apparatus 10.

The model generating apparatus 10 has an input device 13 such as a keyboard and an output device 14 such as a display. The operator can enter operator data, maintenance data, failure data, and the like by operating the input device 13. The input information entered by such an operation is also registered in the database 11. The model generating apparatus 10 also has the function of setting a plurality of regions in a product to be tested and generating a process-quality model on the basis of process state data and test result data in the plurality of regions. In addition, the model generating apparatus 10 also has the function of monitoring various data and the function of performing detection, classification, and prediction on anomaly and failures on the basis of a completed process-quality model. Concrete configurations of the functions will be described later.

FIG. 5 shows a general configuration of the process equipment 2. The process equipment 2 executes a process of coating a glass substrate with resist and includes the resist coater 20 shown in FIG. 2. The process equipment 2 also includes a device controller 15 for controlling operations of the components of the resist coater 20.

The device controller 15 obtains the recipe No. sent from the production control system 9 via the MES network 8. The device controller 15 has a table showing the correspondence between the recipe Nos. and processes actually performed, and controls the operation of the process equipment 2 in accordance with the obtained recipe No.

The operations of the components of the resist coater 20 are performed on the basis of a control instruction from the device controller 15. Data or a signal indicative of the control instruction (set value, operation on/off instruction, and the like), measurement data of an operation state (resist temperature, resist viscosity, resist flow rate, and the like), position information of the nozzle head 22 obtained from the first encoder 18, and the like is sent through an analog input interface 38 or a digital input interface 39 via a sensor bus 40 ad is obtained by the process data collecting device 4. Further, the lot ID (or product ID), time of unloading from the preceding device, and loading time are recognized by an ID controller 42 on the basis of the data read by the RF-ID read/write head 6, and are sent to the sensor bus 40 via a serial interface 43 and obtained by the process data collecting device 4. Further, the process equipment 2 has a temperature sensor 45 and a humidity sensor 46 for measuring ambient temperature and ambient humidity. Data detected by the sensors 45 and 46 is collected through the analog input interface 38 by the process data collecting device 4 via the sensor bus 40.

The process equipment 2 has a signal tower (signal light) 47 for notifying a surrounding operator of its operating conditions (operating state, stop state, the presence/absence of anomaly, and the like). A control of turning on the signal tower 47 is also performed by a control instruction from the device controller 15. The control instruction to the signal tower 47 is also sent to the process data collecting device 4. On completion of a process, the device controller 15 rings a chime from a speaker 48. A “process completion” notification signal is also sent to the process data collecting device 4.

As described above, the process data collecting device 4 collects data (information) generated and obtained by the process equipment 2, and outputs the data to the EES network 7. The kind of data to be collected is not limited to the above-described data. More information can be also obtained.

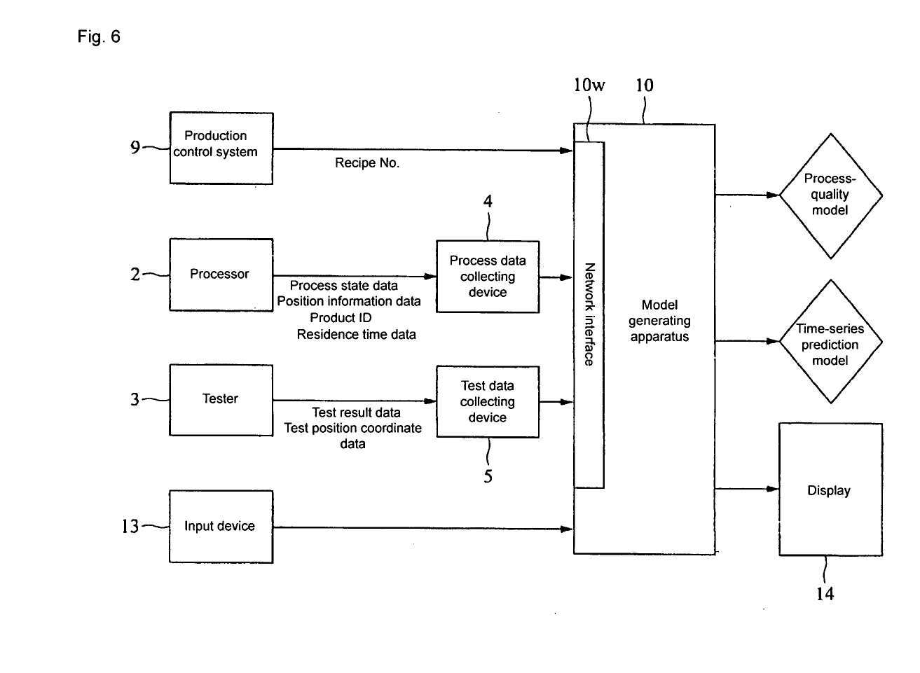

FIG. 6 is a diagram showing a connection state of the devices constructing the system illustrated in FIG. 1 by paying attention to transmission/reception of data. Specifically, the process state data, position information, product ID, and residence time data obtained at the process equipment 2 are associated with each other or added with information that can establish association, and the resultant data is transmitted via the process data collecting device 4 to the model generating apparatus 10. Similarly, the test result data and the test position coordinate data obtained by the test equipment 3 is also associated with each other or added with information that can establish association, and the resultant data is transmitted via the test data collecting device 5 to the model generating apparatus 10. The model generating apparatus 10 has a network interface 10w to be connected to the EES network 7, and receives various data output from the process data collecting device 4 and the test data collecting device 5 via the network interface 10w. The network interface 10w functions as: a first input unit for inputting the process state data; a second input unit for inputting the test result information; a third input unit for inputting position data that specifies the position where the process (resist coating process) is performed on the glass substrate in the process equipment 2; a fourth input unit for inputting the test position coordinate data (test position information) that specifies the position where a test is performed in the glass substrate; and a fifth input unit for inputting the product ID that specifies an object.

Further, the model generating apparatus 10 also receives data (recipe No. and the like) transmitted from the production control system 9 via the network interface 10w. In addition, various data is supplied to the model generating apparatus 10 also from the input device 13 as a human-machine interface (HMI: such as a keyboard connected to the model generating apparatus 10) (a sixth input unit for inputting failure information and a seventh input unit for inputting process supplementary information). The methods of inputting data to the model generating apparatus 10 are not limited to the above methods. An inputting method using radio communication, an inputting method using a storing medium, and the like can be properly used.

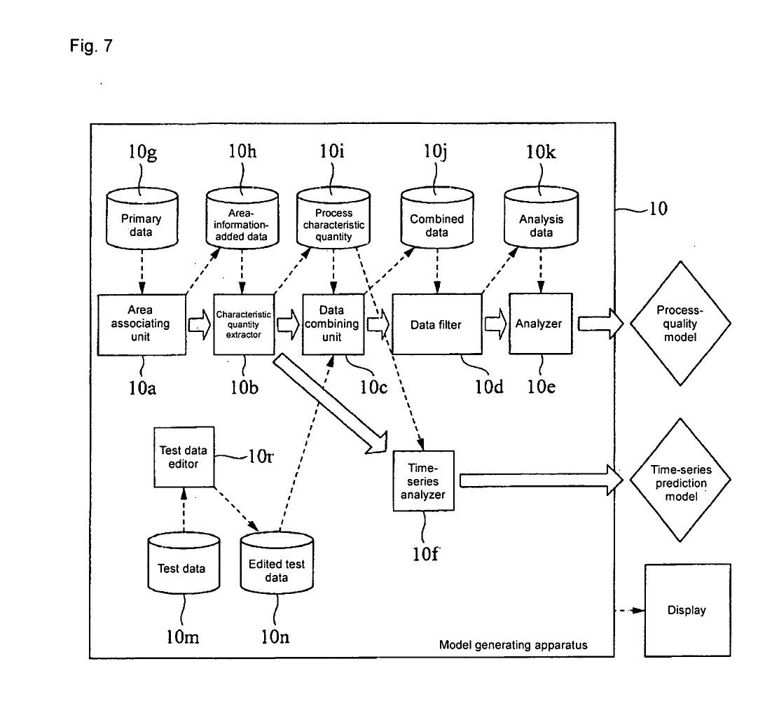

FIG. 7 shows the internal configuration of the model generating apparatus 10. In the model generating apparatus 10, process function units described below are realized by an application program that runs on the operating system of the model generating apparatus 10. Specifically, the process function units of the model generating apparatus 10 includes an area associating unit (area associating means) 10a, a characteristic quantity extractor (characteristic quantity extracting means) 10b, a data combining unit (test result associating means) 10c, a data filter 10d, an analyzer (analyzing means) 10e, a test data editor 10r, and a time-series analyzer (time-series analyzing means) 10f. The components can be also realized by dedicated hardware (circuits).

The model generating apparatus 10 further includes, as storages for storing data to be accessed by the process function units, a primary data storage (storing means for storing process state information) 10g, an area-information-added-data storage 10h, a process characteristic quantity storage 10i, a combined-data storage 10j, an analysis data storage 10k, a test data storage 10m, and an edited test data storage 10n. The storages are provided in the database 11. In the present invention, the storages may be provided in, other than the database 11, storing devices such as a memory and a hard disk of the model generating apparatus 10 or storing devices of another computer performing communication with the model generating apparatus.

The model generating apparatus 10 can be also constructed as follows. As a computer connected to the EES network 7, a client computer performing communications with the process equipment 2 and the test equipment 3 and processes of a human-machine interface is used. A server computer for performing communications with the client computer is provided, and the process function units are realized in the server computer. It is also possible to set the model generating apparatus 10 in a remote place and perform communication with a process equipment or the like in a production site via a communication line such as the Internet. There are alternative various modifications of the configuration of the computer realizing the model generating apparatus 10 and the data transfer method.

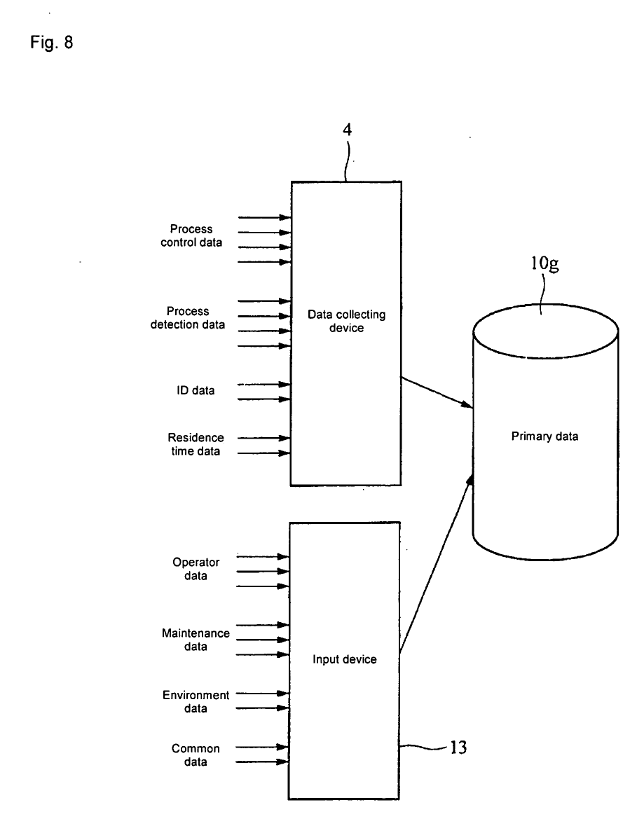

FIG. 8 shows data entered to the model generating apparatus 10. The primary data storage 10g stores data collected from the process equipment 2 by the process data collecting device 4 and data entered by the operator via the input device 13. In the data sent from the process data collecting device 4, the process state data and the residence time data (data indicative of a period of time since time of unloading from a preceding apparatus to time of loading) is associated with the product ID and stored in the primary data storage 10g.

The process state data is constructed by process control data and process detection data. The process control data shows state of various control data output from the device controller 15 of the process equipment 2, and various control signals output from the device controller 15. The control data and the control signals include a motor rotational speed set value, a resist discharge nozzle travel speed set value, a resist flow rate set value, a resist temperature set value, an on/off state of a resist valve, a process completion chime, and light-on of a signal tower.

The process detection data is data obtained by various detectors of the process equipment 2, and includes motor rotational speed, resist flow rate, resist temperature, resist viscosity, resist discharge nozzle travel speed and resist discharge nozzle position information (position data that specifies the position of the resist coating process) obtained on the basis of an output of the first encoder 18, ambient temperature detected by the temperature sensor 45, and ambient humidity detected by the humidity sensor 46.

In the embodiment, a control signal output from the device controller 15 is converted as data and the data is sent to the model generating apparatus 10 by network communication. It is also possible to branch the output line of the control signal and send the control signal as it is to the model generating apparatus 10. In this case, the state of the control signal is converted to data in correspondence with time in the model generating apparatus 10, and the data is stored in the primary data storage 10g.

The lot No., ID data such as lot ID, residence time data (the difference between the time of unloading from the preceding apparatus and loading time), and the like obtained via the RF-ID read/write head 6 are also supplied from the data collecting device 4 to the primary data storage 10g.

From the input device 13, operator data, maintenance data, environment data, and common data is entered. The data is also stored in the primary data storage 10g. The operator data includes operator ID, device ID, start/end, and the like. The operator enters the data from the input device at the start and end of the operation.

The maintenance data denotes pump reproduction information, resist exchange information, and the like. When an operator performs an operation, the operator registers the maintenance data. Specifically, when an operator reproduces a pump or the like in the device for checkup or cleaning, the operator enters the data of the operation from the input device 13. When the operator replaces the resist, the operator enters the name of the resist replaced together with date and time information by using the input device 13.

The environment data includes special weather information (storm, thunderbolt, and the like) at the time of operation as one of factors exerting an influence on the quality of the product and seismic intensity information when an earthquake occurs. In the case where the information exists, the operator registers the environment data together with the date and time information, device ID, and the like.

The common data may be any other arbitrary input information. To increase precision of the process-quality model, option selecting information and free description information from the input device 13 is allowed to be entered so that a factor which may be related to the quality of a product can be entered without constraints. It enables the operator to enter, at any time, information of various events such as information which seems, for a process engineer or the operator of the device, to exert an influence on finishing of products and information of failures spontaneously occur. The information is also included in analysis data and can be analyzed.

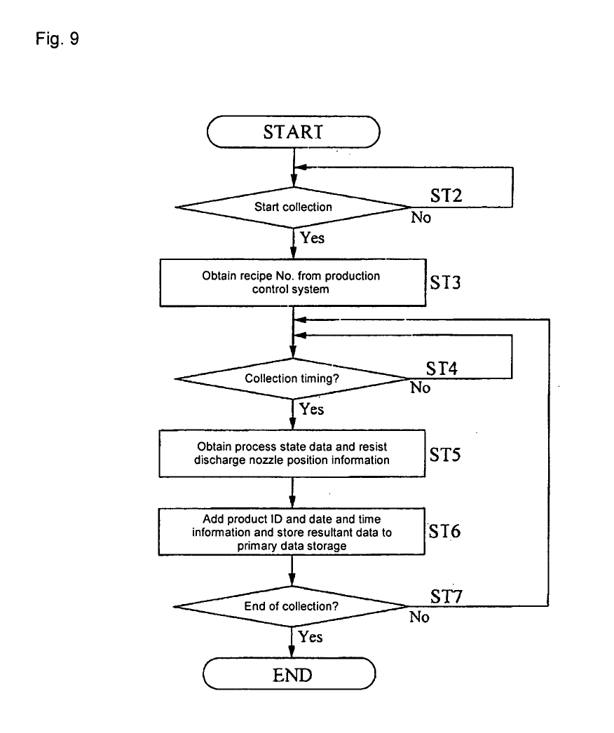

FIG. 9 is a flowchart showing data collection in the process data collecting device 4 and process of registering data to the primary data storage 10g. In the embodiment, the period of execution of a process, that is, the period in which process of coating the glass substrate with a resist is the data collecting period. In the data collecting period, data is sampled in predetermined cycles. The process data collecting device 4 waits until the process by the process equipment 2 on a product starts and it can be determined that collection has to start (ST2). The start of collection can be determined, for example, on condition that a resist discharge nozzle discharge start control instruction becomes ON from OFF. Obviously, another condition may be used as a start condition.

When the collection start condition is set (“Yes” in step ST2 of branch determination), the process data collecting device 4 obtains the recipe No. being processed at present, which is output from the production control system 9 (ST3), and waits for a collection timing (ST4). The collection timing can be determined by detecting, for example, whether it is a predetermined sampling cycle or not.

When it is a collection timing (“Yes” in ST4), the process data collecting device 4 obtains various process state data at that time and resist discharge nozzle position data at the collection timing obtained from an output (encoder information) of the first encoder 18 (ST5).

Subsequently, the process data collecting device 4 adds product ID and date and time information to the obtained process state data and the position data, and transmits the obtained data to the model generating apparatus 10. The model generating apparatus 10 stores the transmitted data in the primary data storage 10g (ST6). The date and time information to be added to data is automatically added as a time stamp on the basis of an internal clock of the process data collecting device 4. Alternatively, the date and time information may be added on the side of the model generating apparatus 10.

After that, whether collection is finished or not is determined (ST7). Specifically, whether the process (in this case, resist coating process) on the product is finished or not is determined. To be concrete, for example, when a resist discharge nozzle discharge end signal is changed from OFF to ON, the end of collection can be determined.

When the resist coating process continues, the branch determination in step ST7 is “No”. The process data collecting device 4 returns to ST4 and executes the processes of the above-described steps ST4 to ST6. On the other hand, when the resist coating process is finished, the data collection is finished.

The process data collecting device 4 associates the residence time data of residence time from the preceding apparatus with the product ID. The associated product ID of the product and the residence time data is transmitted to the model generating apparatus 10 at least once during the period in which the product specified by the product ID is processed. The model generating apparatus 10 stores the transmitted residence time data to the primary data storage 10g.

As data entered by using the input device 13, arbitrary date and time designated by the operator can be entered. By allowing designation of an operator, for example, various works can be registered together with date and time later like a daily report. Consequently, whether a work exerts an influence on the quality of a product or not can be verified.

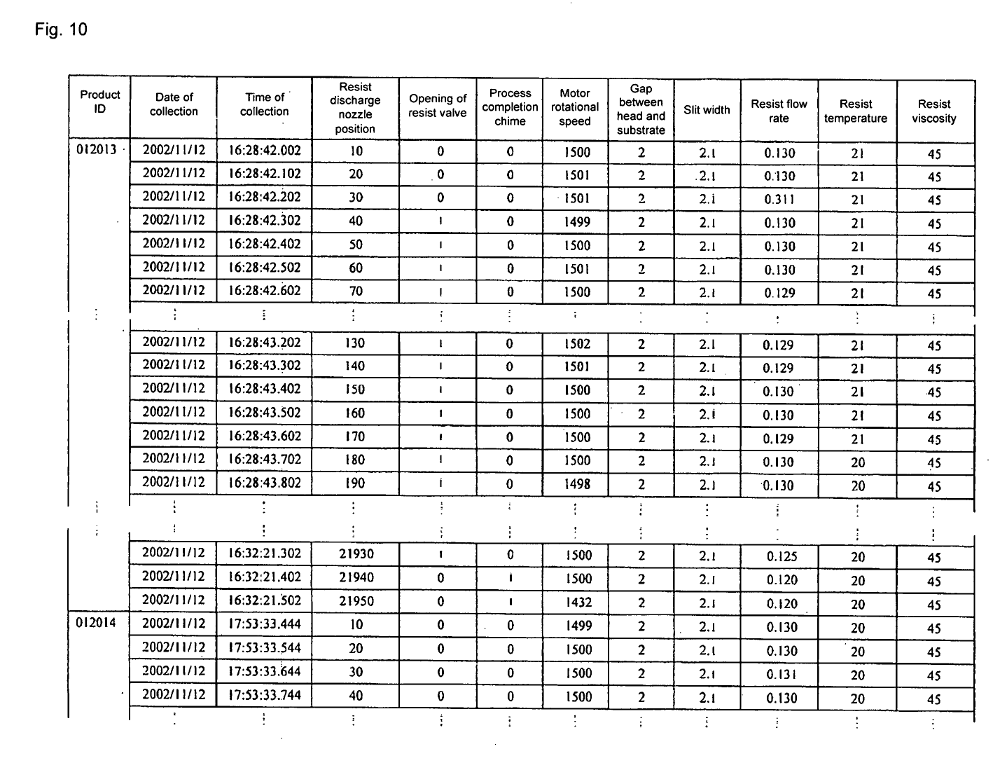

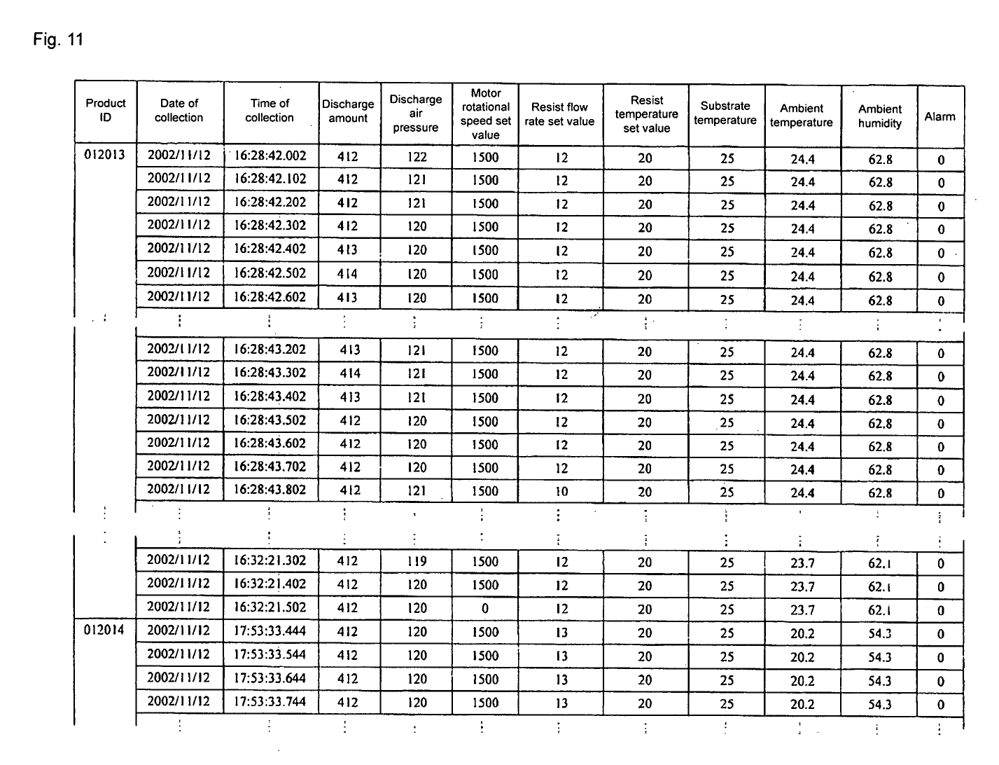

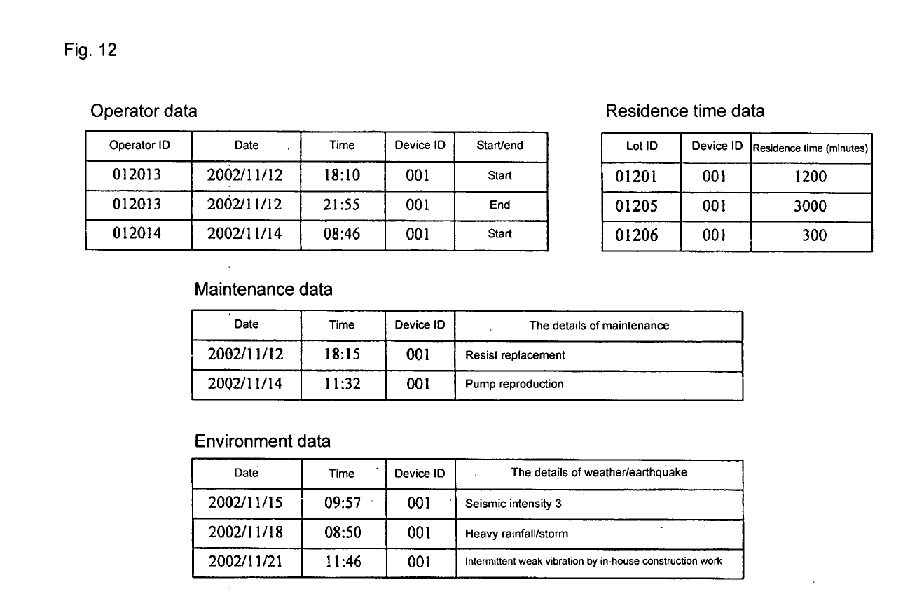

FIGS. 10 to 12 show an example of the structure of data stored in the primary data storage 10g. Although it is shown in two drawings for convenience, FIGS. 10 and 11 show a table of process state data using, as keys, the product ID, resist discharge nozzle position data, collection date, and collection time. The residence time data supplied from the data collecting device, and operator data, maintenance data, environment data, and the like entered from the input device 13 does not change with time during execution of one process and is not always generated in each process. As shown in FIG. 12, a database in a table form is generated for each kind and is stored in the primary data storage 10g.

In the test data storage 10m in FIG. 7, test result data collected from the test equipment 3 by the test data collecting device 5 is stored. The test result data includes information such as test date and time, device ID, test point No. specifying the test position, and test position coordinates, and information of test results such as film thickness data.

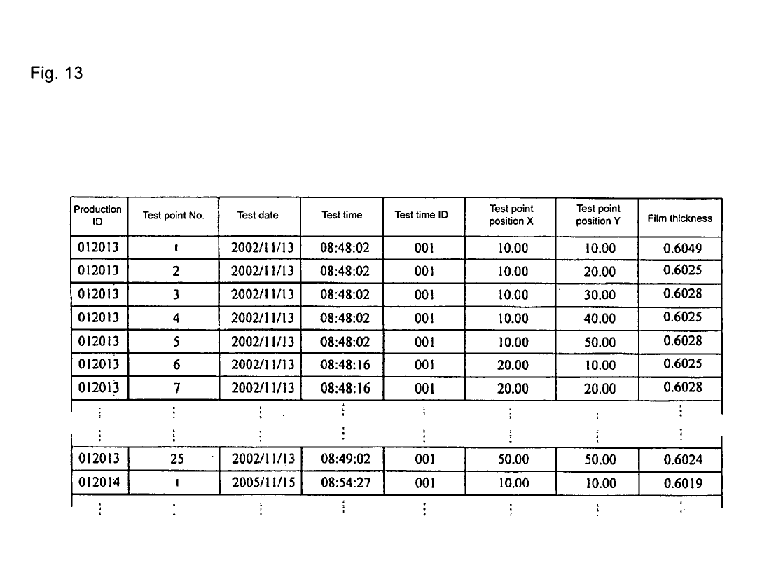

As described above with reference to FIGS. 3 and 4, measurement of the film thickness in the test equipment 3 is performed in a plurality of points. Concretely, measurement of the film thickness is performed in total 25 test points P in a single glass substrate. As a result, as shown in FIG. 13, as film thickness test data, data of film thickness in test point Nos. 1 to 25 of a single glass substrate (product ID: 012013) is collected and stored in a table form in the test data storage 10m.

Although not shown, when failure data entered by the operator by operating the input device 13 exists, in the case of managing the failure data, it is sufficient to provide a failure data storage in the model generating apparatus 10 and store the failure data in the storage. Examples of the failure data to be stored in the failure data storage are failure time, device ID, the failure, lot ID, and arbitrary input information.

As described above, a large amount of various data from the devices is entered to the model generating apparatus 10 and stored in proper storages. On the basis of the data obtained, the model generating apparatus 10 performs a predetermined process to generate a process-quality model. A concrete example is as follows.

First, various data (process state data, resist discharge nozzle position data, and residence time data) stored in the primary data storage 10g is supplied to the area associating unit 10a where a plurality of areas are set in the plane of a product (glass substrate) and area IDs for identifying the set areas are given. The data stored in the primary data storage 10g is grouped in area units on the basis of the resist coating nozzle position data.

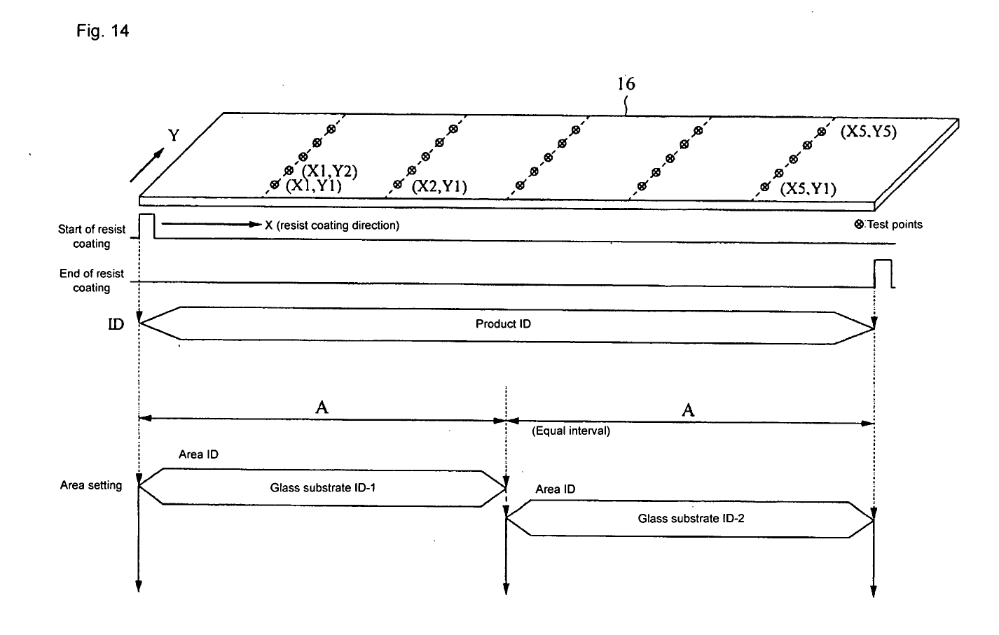

Each of FIGS. 14 to 16 shows an example of setting areas and giving area IDs in the resist coating process of the slit method (spinless method). FIG. 14 relates to a method of setting an area for every width of A pulses (which are set arbitrarily) in the X axis direction on the basis of an output of the encoder 18 in a single glass substrate 16 to be processed. It is also possible to set areas so as to equally divide the glass substrate 16. As area IDs assigned to the areas, subscripts are added in ascending order from 1 to the product IDs. In this example, two equally divided areas are set in a single glass substrate 16. In the first area (product ID-1), there are test points having test position coordinates X1, X2, and X3. In the second area (product ID-2), there are test points having test position coordinates X4 and X5. A plurality of pieces of test data exist in each area. Obviously, the number of divisions is arbitrary. It is also possible to set three or more areas by properly setting the pulse number width.

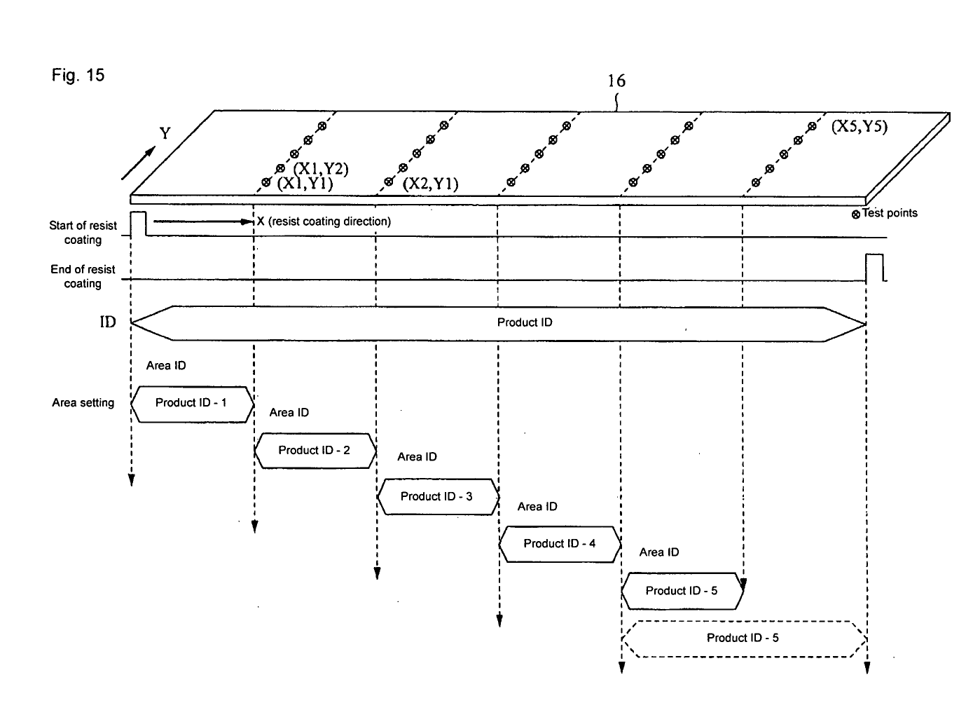

FIG. 15 relates to a method of setting areas using test points. Specifically, at the time of coating the glass substrate 16 with a resist, a first area is set from a coating start point to a position (including the position) corresponding to the first test position coordinate X1 (in the flow direction), and an area ID assigned to the area is “product ID-1”. The test point of the test position coordinate X1 is included in the first area, and the other test points are set in a similar manner. A second area is set from a position after the test position coordinate X1 to a position (including the position) corresponding to the test position coordinate X2 and an area ID assigned to the area is “product ID-2”. In such a manner, assignment of an area ID to an area is repeated. The last area (n-th area: n=5 in the embodiment) in the single glass substrate is set from a position after the test position coordinate X(n−1) to a position (including the position) corresponding to the test position coordinate Xn, and an area ID assigned to the area is “product ID-n”. In the case of setting areas by using the test points as a reference, no test point is included from a position after the test position coordinate Xn to the coating end point. Consequently, the area is not included in any of the areas and process state data collected in the area is not used for data analysis.

For example, as shown by broken lines in FIG. 15, the n-th area is set from a position after the test position coordinate X(n−1) to the coating end point (including the position), and an analysis may be made on the basis of all of process state data and the other data.

Further, in the example shown in FIG. 15, the start position of each of the areas does not include a test point and the end position includes a test point. Alternatively, the start position may include a test point and the end position may not include a test point.

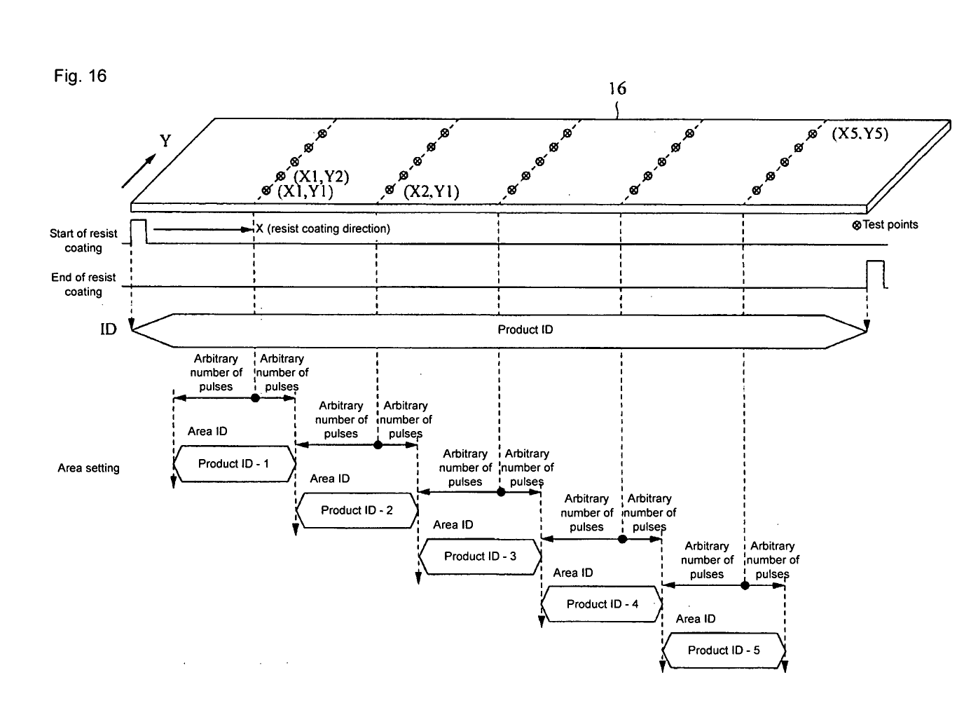

In FIG. 16, at the time of coating the glass substrate 16 with a resist, the position corresponding to the test position coordinate X1 (in the flow direction) is used as a reference, a first area is specified by arbitrary pulses before and after the reference position, and an area ID assigned to the area is “product ID-1”. A second area is set as an interval specified by arbitrary pulses before and after the position corresponding to the test position coordinate X2 as a reference position. An area ID assigned to the area is “product ID-2”. In such a manner, assignment of an area ID to an area is repeated. The n-th area as the last area in the single glass substrate (area ID: product ID-n) is set as an interval specified by arbitrary pulses before and after a position corresponding to the test position coordinate Xn as a reference. The interval (length) before a test point P of the area and the interval after the test point P of the area may be different from each other as shown in FIG. 16 or the same.

As shown in FIG. 16, it is preferable to set the number pulses so that the neighboring areas are continuous for the reason that collected process state data can be used without waste and a better analysis can be conducted. However, in the present invention, neighboring areas do not always have to be continuous but may be overlapped.

As described above, various data (process state data, resist coating nozzle position data, and residence time data) stored in the primary data storage 10g is associated with areas (divided into groups) by the area associating unit 10a, and the area ID is set for each of the areas. When the information stored in the primary data storage 10g is associated with an area, the result is stored together with the area ID into the area-information-added-data storage 10h.

The process state data in the various data stored in the area-information-added-data storage 10h is called by the characteristic quantity extractor 10b where a characteristic quantity is extracted every area, and the extracted process characteristic quantity data is stored in the process characteristic quantity storage 10i. The residence time data is not time-series information but information generally given to a process in a specific process equipment, so that it is stored as the characteristic quantity in the process characteristic quantity storage 10i.

Candidates of a characteristic quantity to be extracted are average value, maximum value, minimum value, standard deviation, accumulation value, threshold (maximum value-minimum value), geometrical mean, harmonic mean, median, 25 percentile, 75 percentile, degree of distortion, median term average, acceleration, and kurtosis. Obviously, other characteristic quantities can be also employed. Any of the listed candidates may be selected as a characteristic quantity to be extracted.

For example, average value, maximum value, minimum value, standard deviation, accumulation value, threshold (maximum value-minimum value), . . . of “resist coating amount”, average value, maximum value, minimum value, standard deviation, accumulation value, threshold (maximum value-minimum value), . . . of “resist coating temperature”, and the process characteristic quantities of the others are extracted.

In such a manner, all of characteristic quantities of kinds common to the items (numerical data) in the process state data are extracted area by area. The characteristic quantity extractor 10b generates process characteristic quantity data in a table structure in which all of extracted characteristic quantities are associated with area IDs and stores it in the process characteristic quantity storage 10i.

On the other hand, the various data stored in the test data storage 10m in FIG. 7 is called and edited by the test data editor 10r and the edited test data is stored in the edited test data storage 10n.

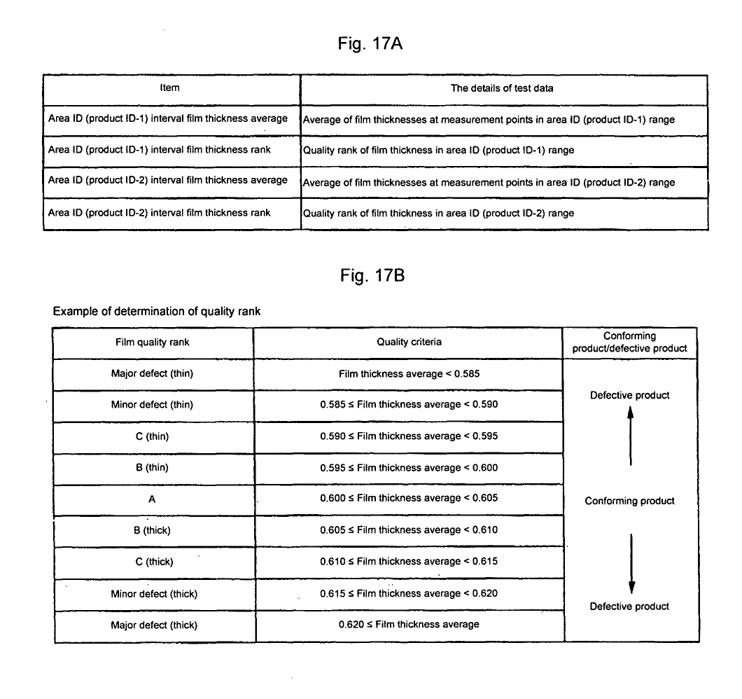

FIGS. 17A and 17B show the meaning of internal data in the edited test data storage 10n. In the case where a plurality of pieces of test result data exist in one area, test result data is generated by an average value of test result data in the range of the area or by other methods. In the example of FIG. 14, test result data in the first area is generated by an average value of test result data in 15 points of the test position coordinates X1, X2, and X3. Test result data in the second area is generated by an average value of test result data in 10 points of the test position coordinates X4 and X5.

Further, the quality (film quality) is ranked on the basis of quality criteria shown in FIG. 17B. The quality is ranked as A, B, and C in the normal range (conforming product) on the basis of film thickness average in the glass substrate. Further, the quality of defectives is ranked as thickness minor defects (thick/thin) close to a conforming product and thickness major defects (thick/thin) apart from a conforming product.

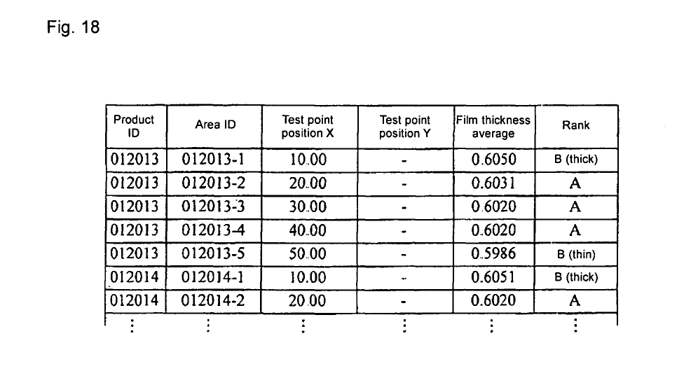

FIG. 18 shows an example of the data structure of the edited test data obtained by the test data editor 10r and stored in the edited test data storage 10n. The film thickness (in the case where a plurality of pieces of test result data exist in the same test position coordinate X, the average value), the film rank (quality), and test position coordinates (X, Y) are stored on the area ID unit basis. As obvious from the diagram, an averaging process is performed on the area ID unit basis, there is no information related to the Y coordinate of each test point.

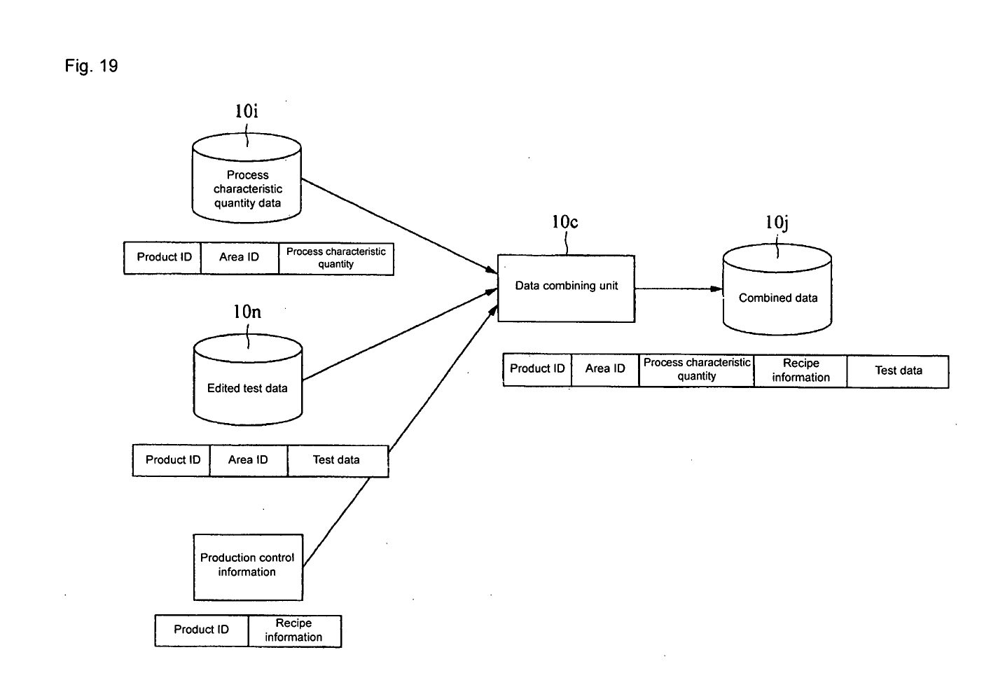

FIG. 19 shows the functions of the data combining unit 10c in FIG. 7. The data combining unit 10c obtains data stored in the process characteristic quantity storage 10i and the edited test data storage 10n and, further product control information (recipe No.) obtained from the production control system 9, and combines the obtained data on the area unit basis using the recipe No. and the product ID as keys. The data combining unit 10c stores the combined data into the combined-data storage 10j. The data stored in the combined-data storage 10j has the table structure in which product ID, area ID, process characteristic quantity, recipe information, and test data are associated with each other as shown below the data combining unit 10c.

Although not shown, process supplementary data can be also added to the combined data. The process supplementary data is data to be given inclusively to one process and is not used for calculating the process characteristic quantity. For example, the operator data, maintenance data, environment data, and data obtained by encoding those data shown in FIG. 12 is process supplementary data. A process of associating the operator data, maintenance data, and environment data with a related lot ID is performed before the data is used in the data combining unit 10c on the basis of the date and time information, device ID information, and the like to which those data is associated.

The data filter 10d in FIG. 7 reads the combined data stored in the combined-data storage 10j and eliminates abnormal data of the process characteristic quantity. The data filter 10d stores the resultant data as analysis data in the analysis data storage 10k. The abnormal data denotes data including, for example, a numerical value which is impossible in practice. Elimination of the data can be realized by an analysis data pre-processing method which is generally performed.

The analyzer 10e reads the analysis data stored in the analysis data storage 10k, performs an analysis by a decision tree method as a general analyzing method of data mining, and generates a process-quality model as a collection of rules of process states in which a conforming or non-conforming product is generated. The process-quality model obtained by the analyzer 10e is stored and held in, for example, the database 11 and used for evaluation hereinafter.

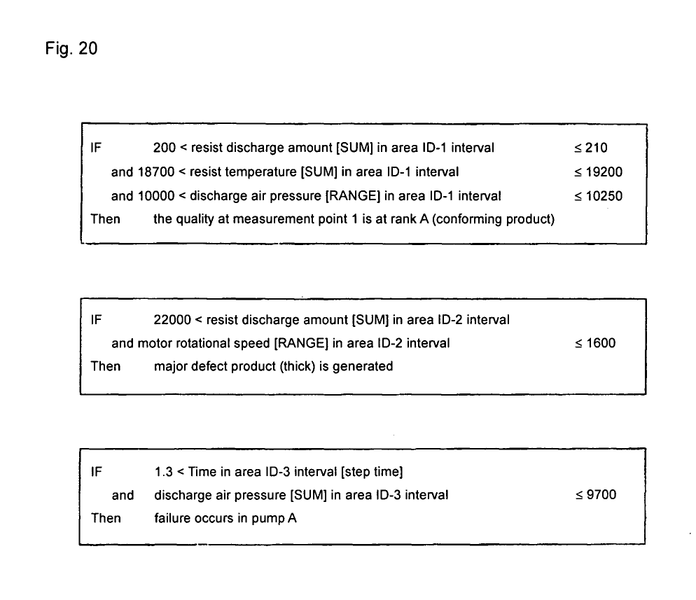

FIG. 20 shows an example of the process-quality model. In the example, the relations among the area, the numeral range of the process characteristic quantity, and the test result are shown by the IF-THEN rule statement. FIG. 20 shows three rule statements. In practice, a number of rule states are generated. In the IF part in the rule statement, the numerical value range of the process characteristic quantity in a certain area is shown. In the THEN part, the test result data of the product is written. In the IF part, in some cases, the presence/absence of process supplementary data is shown.

Concrete description will be given along the uppermost rule expression. The first line of the IF part shows a condition that SUM (accumulation value) of the resist coating amount in the first area is larger than 200 milliliters and equal to or smaller than 210 milliliters (the unit of the numerical value is not shown). The rule expression includes three IF conditional statements (the other two statements will not be described in detail and [RANGE] denotes the threshold (maximum value-minimum value)). When all of the conditions connected by “and” are satisfied, the IF conditions are satisfied as a whole. The THEN part indicates that the quality of the product is the rank A (conforming product). That is, the rule statement indicates that if the AND of the three IF statements is satisfied, there is a tendency that a conforming product can be obtained.

It is understood from the rule statements as shown in FIG. 20 that the relation between the process characteristic quantity in a specific area and a numerical value range (or a combination of relations) exerts an influence on a test result of a product. From the rule statement constructing a process-quality model, the relation between a process state and a product test result and tendencies can be known. As shown by the lowest rule statement in FIG. 20, a rule statement indicative of the relation between the process state and a failure or anomaly of the process equipment can be also obtained.

Many liquid crystal panel manufacturing apparatuses have tendency such that the characteristics change in a certain direction as the process is repeated. In the embodiment, the direction of such a change is detected by applying a time-series prediction (trend prediction) model in the time-series analyzer 10f. Before a product becomes faulty, an alarm is output or date and time of occurrence of a failure is predicated.

As the time-series prediction model, for example, an exponential smoothing model and an auto regressive integrated moving average (ARIMA) model can be used. The time-series prediction model is generated by using an analysis engine adapted to a concrete model used and, as necessary, setting a parameter. The exponential smoothing model is adapted to predict a short-term trend, so that it is used for prediction of a failure which occurs spontaneously, and the like. On the other hand, the ARIMA model is adapted to predict a long-term trend, so that it is used for prediction of timings of a failure and replacement caused by deterioration with time.

The time-series prediction is performed for the process characteristic quantity as an item existing in the rule statement of the process-quality model. A failure prediction determination is performed by using a numerical value shown in the rule statement as a threshold.

As determination data (process characteristic quantity) used at the time of performing time-series prediction, data obtained by performing filtering that eliminates false data (abnormal data) from the process characteristic quantity stored in the process characteristic quantity storage 10i by using the data filter 10d is used.

In the embodiment, the model generating apparatus 10 is provided with the process-quality model generating function by the analyzer 10e and the time-series prediction model generating function by the time-series analyzer 10f. However, it is not necessary to always provide the two functions. A configuration in which the time-series analyzer 10f is not provided may be also employed.

The liquid crystal panel manufacturing process includes many production items, each of the production items has a recipe, and the production items are manufactured while switching the recipes. Therefore, the process-quality model is generated for each of the recipes.

In the foregoing embodiment, one test equipment 3 is prepared for one process equipment 2, and a test on a glass substrate processed by the process equipment 2 is performed by the corresponding test equipment 3. The present invention is not limited to the embodiment. Another system configuration may be employed in which predetermined processes are sequentially performed by a plurality of process equipment 2 and a test is conducted by a single test equipment 3. In this case, the process data collecting devices 4 provided for the process equipment 2 collect process state data so as to be associated with data of positions where the processes are performed on products such as the resist discharge nozzle position data, and send the resultant data to the model generating apparatus 10. The model generating apparatus 10 divides data into groups area by area on the basis of the obtained position data and the process state data, and performs an analysis.

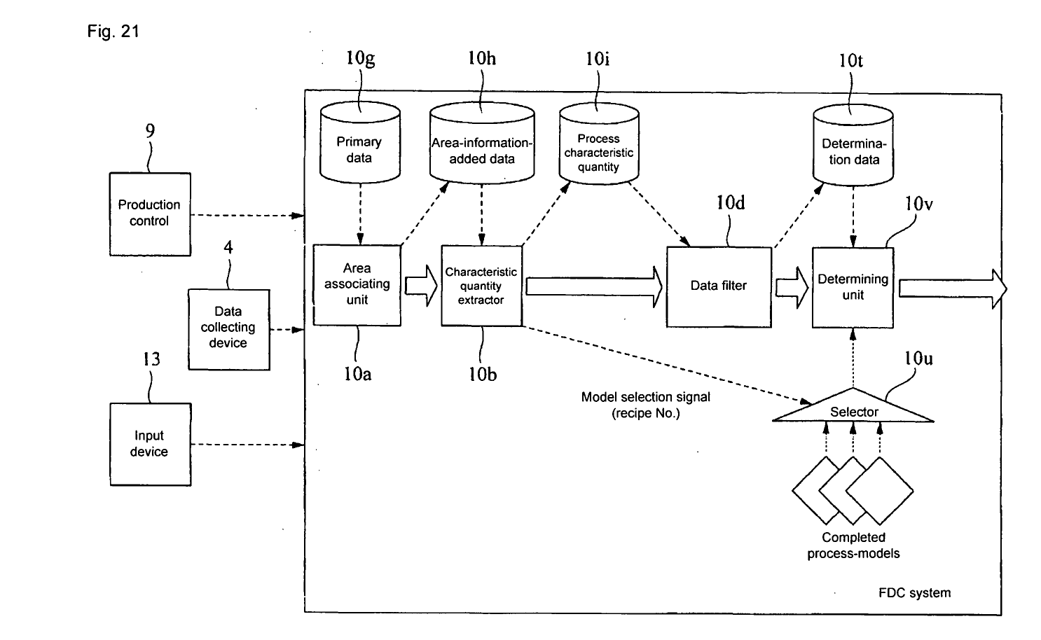

FIG. 21 shows a fault detection and classification (FDC) system as an embodiment of the present invention. The FDC system uses a process-quality model generated by using the model generating apparatus and has the FDC function for predicting the quality of a product being processed and specifying the cause of a fault.

The fault detection and classification function generally includes a function called FDC (Fault Detection and Classification) and is realized by adding some elements to the model generating apparatus 10 of FIG. 7. FIG. 21 shows elements common with those of the model generating apparatus 10 of FIG. 7 and elements added to the model generating apparatus 10 of FIG. 7, which are necessary for the fault detection and classification function.

The FDC system obtains various information from the production control system 9, the process data collecting device 4, and the input device 13 in a manner similar to the model generating apparatus. The information obtained from the devices is basically the same as that of the model generating apparatus. Specifically, the recipe No. is obtained from the production control system 9, and the process state data, the resist coating nozzle position data, the production ID, and the residence time data is obtained from the process data collecting device 4. The various data is stored in the primary data storage 10g in a manner similar to the model generating apparatus.

The various data stored in the primary data storage 10g is read and associated with a set area by the area associating unit 10a. After that, the resultant data is stored in the area-information-added-data storage 10h. Although a process of setting areas in a product (glass substrate) will not be described in detail here, a process similar to the process in the area associating unit 10a in the model generating apparatus is performed. The other process equipment added with the same reference numerals as those of the process equipment in the model generating apparatus perform processes similar to those of the corresponding process equipment.

The various data stored in the area-information-added-data storage 10h is read by the characteristic quantity extractor 10b, and the characteristic quantity of an item preliminarily determined for each area is extracted and stored in the process characteristic quantity storage 10i. Further, in the data filter 10d, the characteristic quantity stored in the process characteristic quantity storage 10i is called and a filtering process that eliminates abnormal data and the like is performed. After that, the resultant data is stored in a determination data storage 10t. The data structure of the determination data stored in the determination data storage 10t is equivalent to a data structure obtained by eliminating the test result data from the analysis data stored in the analysis data storage 10k in the model generating apparatus.

Further, the FDC system has a plurality of process-quality models each generated for each recipe No., and a model selector (process-quality model providing means) 10u selects a desired model on the basis of the obtained recipe No. and gives the selected model to a determining unit (determining means) 10v.

The determining unit 10v reads data from the determination data storage 10t, compares the read data with the rule of the selected process-quality model, and can determine the quality of a product from the value of the determination data corresponding to each of the rules without actually performing a test by a test equipment. The process state data is entered with time, so that a fault can be determined even during a process in the process equipment 2. Therefore, when a fault is detected, by stopping the process in the process equipment 2 at that stage, or stopping transmission to the next process using another apparatus, the process material and time can be prevented from being wasted. Further, a fault and other anomalies of the apparatus itself can be also predicted. Obviously, it is unnecessary to immediately stop the process and manufacture can be continued depending on a fault determined. Therefore, the relation between a fault and a subsequent process is defined in advance, and a defined process is performed.

The determination result can be notified by being displayed on the display device 14. Examples of the notification display are “There is the possibility of a film thickness minor defect. Please test.”, “There is the possibility of a film thickness major defect. Please stop the system.”, “A failure may occur in the pump A. Please check.”, and “A failure may occur soon in the pump A. Forced outage is required.”

As described above, whether a product is conforming or not can be determined or a failure of the system can be predicted prior to a test conducted by the test equipment. Consequently, occurrence of a defective which is disposed can be suppressed as much as possible, and a disposal loss of products and a loss of the process materials can be reduced. In a liquid crystal panel manufacturer, the loss by such disposal is generally large. Even if the process anomaly detection accuracy of 100% cannot be realized, there is an effect of introducing the method. For example, even if the detection accuracy is 50%, a loss according to the accuracy can be reduced. Further, by improving the process-quality model after introduction, improvement by the rest of 50% can be aimed.

By introducing also a time-series prediction model, a determination on the time-series prediction can be also made by the determining unit 10v. An example of notification in this case is “caution: a film thickness major defect product may be manufactured from 14:23 on Dec. 4, 2002”.

Although the examples of applying the present invention to the liquid crystal panel manufacturing process have been described in the foregoing embodiment, the present invention is not limited to the examples but can be applied to various manufacturing processes.

What is claimed is:

1. A model generating apparatus for a process in which a target position of a process sequentially moves over an object and used in the case where a plurality of areas are set on the object, the apparatus comprising:
a first input device for inputting process state information as information related to a state of a process, which is obtained in time sequence during a period in which the process is executed;
a second input device for inputting test result information as information of a test result obtained in each of a plurality of test positions on an object processed in the process;
a characteristic quantity extracting device for extracting a process characteristic quantity from the process state information in each of the areas; and
an analyzing device for generating a process-quality model indicative of the relation between the process characteristic quantity and the test result information by executing an analysis of data mining using the process characteristic quantity and the test result information associated by detecting that the area corresponding to the process characteristic quantity and the area to which the test position belongs are the same.

2. A model generating apparatus according to claim 1, further comprising:
a third input device for inputting process position information specifying a position on the object being processed when the process state information is obtained so that the process position information can be associated with the process state information;
a fourth input device for inputting test position information specifying a test position so that the test position information can be associated with test result information; and
an area associating device for specifying process state information corresponding to each of the areas by using the process position information,
wherein the characteristic quantity extracting device extracts a process characteristic quantity area by area from the process state information in which a corresponding area is specified by the area associating device,
a test result associating device is further provided for specifying test result information corresponding to each of the areas by using the test position information and associating the process characteristic quantity and the test result information corresponding to the same area, and
wherein the analyzing device performs an analysis using the process characteristic quantity and the test result information associated with each other by the test result associating device.

3. A model generating apparatus according to claim 2, further comprising an area setting device for setting the plurality of areas so that at least one test position specified by the test position information is included in each of the areas.

4. A model generating apparatus according to claim 3, wherein the area setting device sets a plurality of areas so that a border between neighboring areas is set by using the test position as a reference and at least one test position is included in each of the areas.

5. A model generating apparatus according to claim 3, wherein the area setting device determines the plurality of areas by setting a predetermined range around each of the test positions.

6. A model generating apparatus according to claim 3, wherein the area setting device sets the plurality of areas by equally dividing the object into predetermined number of areas so that at least one test position is included in each of the areas.

7. A model generating system comprising:
a process information collecting device for collecting, from a process equipment, process state information as information related to state of a process which is a resist coating process for coating a substrate with a resist;
a test equipment for testing film thickness of the resist on an object to which the resist coating process has been executed; and
the model generating apparatus according to claim 1, for inputting the process state information from the process information collecting device, inputting test result information on the film thickness from the test equipment, and generating a process-quality model indicative of the relation between a process characteristic quantity extracted from the process state information and the test result information.

8. A fault detecting apparatus for a process in which a target position of a process sequentially moves over an object and used in the case where a plurality of areas are set on the object, the apparatus comprising:
a first input device for inputting process state information as information related to a state of a process, which is obtained in time sequence during a period in which the process is executed;
a third input device for inputting process position information specifying a position on the object being processed when the process state information is obtained so that the process position information can be associated with the process state information;
a characteristic quantity extracting device for extracting a process characteristic quantity from the process state information in each of the areas;
a storing device in which a process-quality model indicative of the relation between the process characteristic quantity and the test result information is stored; and
a determining device for determining the presence or absence of a fault on the basis of the process characteristic quantity extracted by the characteristic quantity extracting device and the process-quality model stored in the storing device.

9. A model generating method for a process in which a target position of a process sequentially moves over an object and used in the case where a plurality of areas are set on the object, the method comprising:
a step of inputting process state information as information related to a state of a process, which is obtained in time sequence during a period in which the process is executed;
a step of inputting test result information as information of a test result obtained in each of a plurality of test positions on an object processed in the process;
a characteristic quantity extracting step of extracting a process characteristic quantity from the process state information in each of the areas; and
an analyzing step of generating a process-quality model indicative of the relation between the process characteristic quantity and the test result information by executing an analysis of data mining using the process characteristic quantity and the test result information associated by detecting that the area corresponding to the process characteristic quantity and the area to which the test position belongs are the same.

10. A model generating method according to claim 9, further comprising:
a step of inputting process position information specifying a position on the object being processed when the process state information is obtained so that the process position information can be associated with the process state information;
a step of inputting test position information specifying a test position so that the test position information can be associated with test result information; and
an area associating step of specifying process state information corresponding to each of the areas by using the process position information,
wherein the characteristic quantity extracting step is a step of extracting a process characteristic quantity area by area from the process state information in which a corresponding area is specified in the area associating step,
a test result associating step is further provided for specifying test result information corresponding to each of the areas by using the test position information and associating the process characteristic quantity and the test result information corresponding to the same area, and
wherein the analyzing step is executed using the process characteristic quantity and the test result information associated with each other in the test result associating step.

11. A fault detecting method for a process in which a target position of a process sequentially moves over an object and used in the case where a plurality of areas are set on the object, the method comprising:
a step of inputting process state information as information related to a state of a process, which is obtained in time sequence during a period in which the process is executed;
a step of inputting process position information specifying a position on the object being processed when the process state information is obtained so that the process position information can be associated with the process state information;
a characteristic quantity extracting step of extracting a process characteristic quantity from the process state information in each of the areas;
a step of enabling a process-quality model indicative of the relation between the process characteristic quantity and the test result information to be used; and
a determining step of determining the presence or absence of a fault on the basis of the process characteristic quantity extracted in the characteristic quantity extracting step and the process-quality model.
